(19) United States
(12) Patent Application Publication
(10) Pub. No.: US 2010/0088871 A1
(43) Pub. Date: Apr. 15, 2010

(54) Ergonomic Hand-Held Device

(76) Inventor: Doris Chavez, San Antonio, TX (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 12/574,758

(22) Filed: Oct. 7, 2009

Related U.S. Application Data
(60) Provisional application No. 61/103,962, filed on Oct. 9, 2008.

(51) Int. Cl. B25B 27/02

(52) U.S. Cl. 29/278

(57) ABSTRACT

An ergonomic hand-held device is provided to allow a user to easily apply the necessary force required to install a caps into a vial or test tube. The device includes a handle member that is ergonomically shaped to provide a user with maximum comfort while minimizing any physical problems associated with the use of the hands and wrists continuously in a repetitive motion. The device also includes an engaging projecting member that extends from the handle member. The projecting member includes a flat surface at one end such that when engagement with the cap the flat surface lies substantially flush against a bottom wall of a cavity of the cap. Through this configuration, a user generated force is transferred from the handle member through the projecting member, and to the cap, thereby causing the cap into an opening of the vial for locking the cap into a sealed and closed position with the vial.

### CROSS REFERENCE TO RELATED APPLICATIONS

The present application claims the benefit of U.S. Patent Application No. 61/103,962, titled “Ergonomic Hand-held Capping Apparatus For Use With Blood Specimen Vials”, filed on Oct. 9, 2008, which is hereby incorporated by reference herein in its entirety.

### FIELD OF THE INVENTION

The present invention relates generally to a device for installing caps on vials and test tubes, and more particularly to a hand-held device that allows for the quick and easy installation of the caps and is ergonomically designed to prevent carpal tunnel syndrome and other physical problems related to the repetitive movement of the hands.

### BACKGROUND OF THE INVENTION

Test tubes are used extensively in laboratories for containing liquids during experiments. Due to increase in research in the fields of medicine, biology and chemistry, there has been widespread use of test tubes in laboratories throughout the world. Often times it is necessary to mix or transport contained substances within the test tube creating the need for test tube caps that seal the opening of the test tube, thereby holding in the contained substance. Advances in polymer science have led to the creation of plastic polypropylene test tubes and test tube caps that are disposable. These test tubes and test tube caps are inexpensive and do not shatter when dropped.

A wide range of test tubes are available in different sizes and colors, including a 12×75 mm standard sized test tube which is used by many organizations, including the United States military. Various capping structures are used to create a seal between the cap and the test tube. One commonly used capping structure is the flange cap, which consists of two flanges that extend around the outer periphery of the bottom portion of the cap that is inserted into the opening on the top of the test tube. The cap is snapped into a sealed position within the aperture of the test tube, so that a flange that extends from the inner surface of the test tube is pushed between the two flanges extending out from the capping structure.

Laboratories generate large numbers of test tubes on a daily bases that must be sealed with a cap. The task of a person sealing test tubes with various types of caps, and in particular flange caps, is time consuming and requires a repeated movement of the hands in the same manner and position. As a result, the task of repeatedly capping test tubes can lead to carpel tunnel syndrome or other similar illnesses. The prior art details various devices that seek to provide improved means for attaching and detaching caps of various types onto test tubes.

U.S. Pat. No. 4,704,924 issued to Echols on Nov. 10, 1987 describes a device that is used for removing and attaching stoppers, or caps onto the opening of a test tube. Specifically, the device includes a concave recess within an outer hand held device. The concave recess is shaped to engage and grip the cap of a test tube. An absorbent strip within the concave recess absorbs any liquid that escapes from the test tube during the attachment and removal of the cap. By gripping the cap securely within the concave recess, a user generated force on the hand held device, is transferred to the cap, thereby removing it from the opening of the test tube. The device can also be used to place a cap contained within the concave recess into the opening of a test tube and subsequently lock the cap into position by applying a downward force onto the cap through the hand held device.

U.S. Pat. No. 5,746,042 issued to Lombardi on May 5, 1998 describes a hand held mechanical device that is used to install caps on to test tubes. The device includes a housing channel for storing multiple test tube caps and an installation channel that includes a plunger for pushing the caps into a sealed position within the opening of the test tube. The caps are moved from the housing channel into the installation channel through a rotating shuttle member. The movement of the plunger is driven by a user applied force that causes the outer housing of the device to move over the inner housing, subsequently displacing the plunger. The movement of the outer housing of the device over the inner housing in returning to the original position of the outer housing causes the shuttle member to rotate, subsequently moving a new cap into the installation channel from the storage channel. The invention described by the '042 patent is disadvantageous because it is bulky and still requires that a user apply a large force in moving the outer housing with respect to the inner housing in order to drive the plunger so that the necessary force is exerted on the cap for adequate installation and sealing.

U.S. Pat. No. 5,967,001 issued to Regester on Oct. 19, 1999 describes a tool for both installing and removing multiple caps to and from test tubs simultaneously. The device is meant for operation when pluralities of test tubes are placed side by side in a line. A long continuous groove is used to engage and subsequently remove the caps simultaneously when a user generated force is applied to the device. On the opposing side of the device, a series of individual recesses in the same shape as the caps, are used to engage caps that are resting on top of test tubes in an unlocked position. A force is applied to the device, such that the test tube caps that are engaged by the individual recesses of the device are pushed down into a locked position within the opening of the test tube.

The inventions of the prior art have many disadvantages, including size and difficulty of operation, and the need for a device that fits entirely around a test tube cap, thereby making it difficult to quickly remove the device from the installed cap. Therefore, a need exists for a hand held test tube cap installation device that is both light and easy to operate. Furthermore, such a device should make minimal contact with the test tube cap during the installation process, to allow for the quick disengagement of the device from an installed test tube cap.

Diseases such as carpal tunnel syndrome cause severe pain and weakness within the wrists and forearms, and are caused by the repetitive tasks that require constant movement and bending of the wrists into awkward positions. Such tasks include attaching caps to test tubes. In addition to causing pain to the user, the disease also can lead to a decrease in employee productivity levels. As a result, it is important to minimize the onset of carpal tunnel syndrome and other diseases, through the use of alternate means including ergonometric devices in the performance of such tasks. Therefore, a need also exists in the art for an ergonometric design and construction of the hand-held device in order to minimize the occurrence of carpal tunnel syndrome and other related illnesses in attaching caps to test tubes.

### SUMMARY OF THE INVENTION

The present invention overcomes the limitations and disadvantages of the prior art by providing an ergonomic hand-held device that allows a user to easily apply the necessary force required to install a cap into a vial.

In one embodiment, the device comprises a handle member having a top surface and a bottom surface with at least one recessed portion. The device also comprises a projecting member extending from the bottom surface of the handle member. The projecting member comprises a flat surface at one end such that when engagement with the cap said flat surface lies at least substantially flush against a bottom wall of a cavity of the cap. Through this configuration, a user generated force is transferred from the handle member through the projecting member, and to the cap, thereby forcing the cap into opening of the vial for locking the cap into a sealed and closed position within the vial.

Accordingly, it is one object of the present invention to provide a device for installing a cap into an opening situated on top of a test tube or vial.

It is another object of the present invention to provide a device for installing a cap into an opening situated on of a test tube or vial that is hand-held.

It is yet another object of the present invention to provide a hand held device for installing caps into the openings on the top of test tubes that is ergonomically designed to minimize the onset of carpal tunnel syndrome or other degenerative diseases that are caused by the repetitive movement of installing multiple caps for prolonged periods of time.

It is still another object of the present invention to provide a hand held device for installing caps into the openings on the top of test tubes that is both light and easy to operate.

It is furthermore another object of the preset invention to provide a hand held device for installing caps into the opening on the top of test tubes that is inexpensive to manufacture, thereby allowing for widespread usage of the device.

### BRIEF DESCRIPTION OF THE DRAWINGS

The present invention will be more readily understood from the detailed description of exemplary embodiments presented below considered in conjunction with the attached drawings, of which:

FIG. 1 is an exploded top perspective view of a cap installation device in accordance with the present invention;

FIG. 2 is a side sectional view of the device engaging a cap prior to installation on the test tube; and

FIG. 3 is a side sectional view thereof with the cap installed on the test tube.

It is to be understood that the attached drawings are for purposes of illustrating the concepts of the invention and may not be to scale.

### DETAILED DESCRIPTION OF THE INVENTION

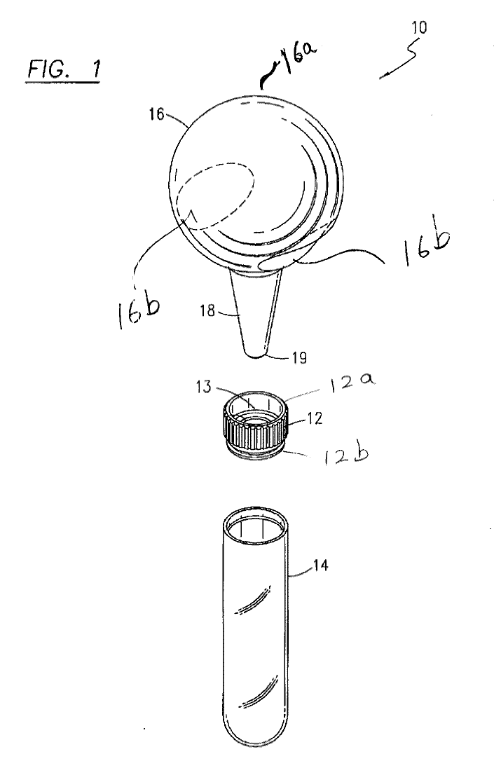

FIG. 1 shows a cross-sectional view of an ergonomic hand-held device 10 for installing a cap 12 on a vial or a test tube 14 according to an embodiment of the present invention. The hand-held device 10 includes an ergonomically designed handle member 16 comprising preferably a top surface 16a for easy gripping and control of the device by a user. Preferably, the top surface 16a is substantially hemispherical in shape, however, one having ordinary skill in the art will approach that other shapes maybe employed. The handle member also includes a plurality of recessed portions 161) and preferably concavely recessed thumb rest surfaces, preferably positioned below the top surface 16a of the handle member 16. The handle member 16 is composed of any suitable compliant material that is sufficiently rigid to adequately transfer forces generated by the user, while still being compliant enough to provide comfort and minimize the effects of carpal tunnel syndrome or other related diseases. Some examples of such material include a polyurethane foam rubber or a contained gel. The device 10 also comprises a projecting member 18 protruding or extending axially from the handle member 16 for engagement into the cap 12, as shown in FIG. 1.

According to a preferred embodiment of the present invention, the projecting member 18, as shown in FIG. 1 is of substantially conical shape with an end portion arranged opposite referenced as 19 that is sized and shaped for engagement into a cavity 13 of the cap 12, without piercing the cap under an applied force. Projecting member 18 can be any suitable shape and size, as long as it functions to engage with the cap 12 and transfer the user applied force from the handle member 16 to the cap 12 to secure the cap 12 to the test tube 14 without causing any damage to the cap 12. Projecting member 18 is fabricated preferably from any rigid material, including a plastic or metal alloy. Also shown in FIG. 1 are an upper section 12a and a lower section 12b of the cap.

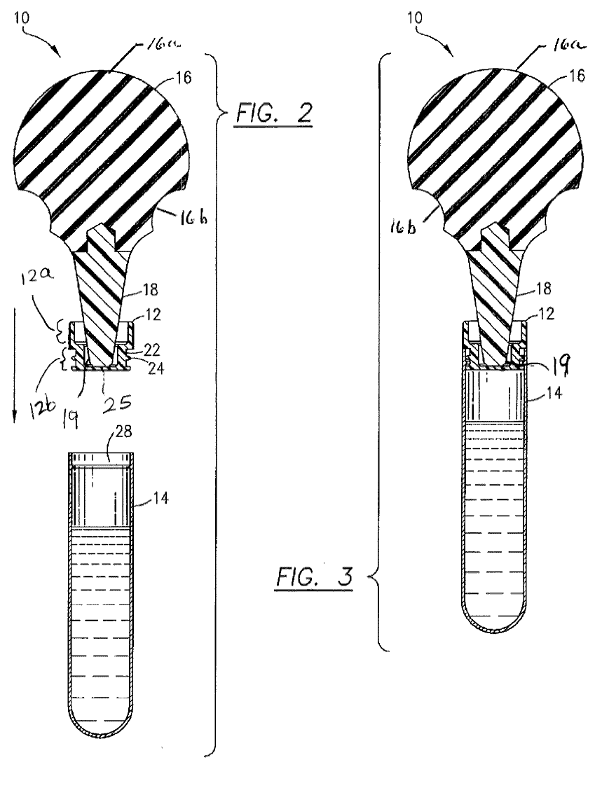

FIGS. 2 and 3 illustrate cross-section views of the hand-held device 10 according to embodiments of the present invention. In a preferred embodiment, the end portion 19 of the projecting member 18 is substantially flat. The end portion 19 of the projecting member 18, when in engagement with the cap 12, lies at least substantially flush against a bottom wall 25 of the cavity 13 of the cap 12. In lying at least substantially flush with the bottom wall 25 of the cavity 13 within the cap 12, the user generated force applied to the handle member 16 is adequately distributed through the projecting member 18 to the cap 12. Furthermore, in lying at least substantially flush with the bottom wall 25 of the cavity 13 of the cap 12, the projecting member 18 and subsequently the handle member 16 engage into the cap 12 by way of a frictional engagement and fit. Accordingly, the projecting member 18 along with the handle member 16 can be disengaged quickly and easily from the cap 12, thereby enabling a user to install a plurality of caps in a short period of time.

In a preferred embodiment of the present invention, the cap 12 is a flange type cap. The present invention can be used with any type of cap that fits on any standard sized test tube, including but not limited to: 12 mm, 13 mm, 16 mm, and 17 mm diameter test tubes and test tube caps. Such cap types can include but are not limited to screw caps or flange caps. As shown in FIG. 2, the flange cap 12 contains an upper and lower flange 22 and 24, respectively extending outward around the periphery of the lower section 12b of the cap 12. According to an embodiment of the present invention, the hand-held device 10 is configured for use in installing a cap 12 into a test tube 14 containing an inwardly pointed flange 28 that extends around the inner periphery of the test tube 14. In locking flange-type cap 12 into a sealed position, the cap 12 is pushed into the opening of the test tube 14 through a downwardly directed force indicated by the arrow shown in FIG. 2. In pushing the cap 12 into the test tube 14, the lower flange 24 is displaced over and beneath the inwardly pointed test tube flange 28, so that the inwardly pointed flange 28 is positioned between the upper and lower flanges 22 and 24 of the cap 12. This in turn secures the cap 12 to the test tube 14 creating a seal about the opening, as shown in FIG. 3.

According to an exemplary embodiment of the present invention, in operation, the hand-held device 10 is placed in use by first placing a cap 12 over the opening of the test tube 14. The user then grasps the concave recessed portions 16b of the hand held member 16 and positions the projecting member 18 into the cavity 13 on top of the cap 12. Finally, a user generates a force in the direction indicated by the arrow shown in FIG. 2 in relation to the test tube 14 and the cap 12. This force is transferred from the handle member 16, through the projecting member 18, and to the cap 12, thereby causing the cap 12 to engage within the opening of the test tube 14 and create a closed and sealed structure, as illustrated in FIG. 3.

It is to be understood that the exemplary embodiments presented herein are merely illustrative of the invention and that many variations of the above-described embodiments may be devised by one skilled in the art without departing from the scope of the invention.

What is claimed is:

1. An ergonomic hand-held device for installing a cap into engagement with a vial, comprising:
a handle member having a top surface and a bottom surface, said handle member comprising at least one recessed portion; and
a projecting member extending from the bottom surface of the handle member, said projecting member having a flat surface at one end such that when engagement with the cap said flat surface lies at least substantially flush against a bottom wall of a cavity of the cap, wherein force generated by the user is transferred from the handle member through the projecting member, and to the cap, thereby causing the cap to engage into an opening of the vial for locking said cap into a sealed and closed position within said vial.

2. The hand-held device of claim 1, wherein said cap comprises an upper and a lower flange extending outwardly around a periphery of a lower section of the cap.

3. The hand-held device of claim 2, wherein said vial comprises an inwardly pointed flange extending around an inner periphery of the vial.

4. The hand-held device of claim 3, wherein said lower flange of the cap is displaced over and beneath the inwardly pointed flange of the vial such that the inward pointed flange is positioned between the upper and the lower flange of the cap to securely seal the cap into the vial.

5. The hand-held device 1, wherein the at least one recessed portion of the handle member is configured to be grasped by the user to apply said force to position the projecting member into engagement in the cavity of the cap.
